(19) United States
(12) Patent Application Publication
(10) Pub. No.: US 2014/0363276 A1
(43) Pub. Date: Dec. 11, 2014

(54) ULTRA HIGH BYPASS RATIO TURBOFAN ENGINE

(71) Applicants: Rolls-Royce Corporation, Indianapolis, IN (US); Rolls-Royce North American Technologies, Inc., Indianapolis, IN (US)

(72) Inventors: Daniel K. Vetters, Indianapolis, IN (US); Michael Karam, Plainfield, IN (US); Roy D. Fulayter, Avon, IN (US)

(73) Assignees: Rolls-Royce Corporation, Indianapolis, IN (US); Rolls-Royce North American Technologies, Inc., Indianapolis, IN (US)

(21) Appl. No.: 14/101,438

(22) Filed: Dec. 10, 2013

Related U.S. Application Data
(60) Provisional application No. 61/800,833, filed on Mar. 15, 2013.

(51) Int. Cl. F02K 3/075

(52) U.S. Cl. CPC F02K 3/075
USPC 415/124.2

(57) ABSTRACT

An ultra high bypass ratio turbofan engine includes a variable pitch fan, a low pressure turbine, a reduction gearbox, and a plurality of outlet guide vanes. The ultra high bypass ratio turbofan engine has a bypass ratio between about 18 and about 40. The variable pitch fan and the low pressure turbine are coupled together by the reduction gearbox. The reduction gearbox reduces the speed of the variable pitch fan relative to the low pressure turbine. The plurality of outlet guide vanes are spaced aft of the variable pitch fan and are axially swept. The variable pitch fan and the low pressure turbine are configured to generate a fan pressure ratio between about 1.15 and about 1.24.

### CROSS REFERENCE TO RELATED APPLICATIONS

This application claims priority to and the benefit of U.S. Provisional Patent Application No. 61/800,833, filed 15 Mar. 2013, the disclosure of which is now expressly incorporated herein by reference.

### TECHNICAL FIELD

The present disclosure relates to ultra high bypass ratio turbofan engines. More particularly, but not exclusively, the present disclosure relates to architectural components and cycle parameters to reduce fuel burn and reduce noise of ultra high bypass ratio turbofan engines.

### BACKGROUND

Turbofan type gas turbine engines that have an ultra high bypass ratio, and the reduction of fuel consumption and noise experienced by such gas turbine engines, remains an area of interest. Some existing systems and methods have various shortcomings, drawbacks, and disadvantages relative to certain applications. Accordingly, there remains a need for further contributions in this area of technology.

### SUMMARY

One embodiment of the present application is an ultra high bypass ratio turbofan engine that comprises a combination of architectural components, and cycle and aero parameters that result in the delivery of a lower fan pressure ratio and lower fuel burn and noise. Other embodiments include unique methods, systems, devices, and apparatus to provide for an ultra high bypass ration turbofan engine. Further embodiments, forms, objects, aspects, benefits, features, and advantages of the present application shall become apparent from the description and figures provided herewith.

### BRIEF DESCRIPTION OF THE FIGURES

Features of the application will be better understood from the following detailed description when considered in reference to the accompanying drawings, in which:

FIG. 1 is an axial sectional schematic showing an ultra high bypass ratio turbofan engine according to an embodiment;

FIG. 2 is a graph showing percent height versus outlet vane guide Mach number according to an embodiment;

FIG. 3 is an axial sectional schematic showing a bleed air inlet anti-icing system incorporated into a nacelle according to an embodiment;

FIG. 4 is a graph showing nacelle weight versus fan tip radius for various fan pressure ratios according to an embodiment;

FIG. 5 is a graph showing nacelle drag versus fan tip radius for various fan pressure ratios according to an embodiment; and

FIG. 6 is a graph showing inlet throat Mach number versus propulsive fan radius for various fan pressure ratios according to an embodiment.

### DETAILED DESCRIPTION OF REPRESENTATIVE EMBODIMENTS

While the present disclosure can take many different forms, for the purpose of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications of the described embodiments, and any further applications of the principles of the disclosure as described herein, are contemplated as would normally occur to one skilled in the art to which the disclosure relates.

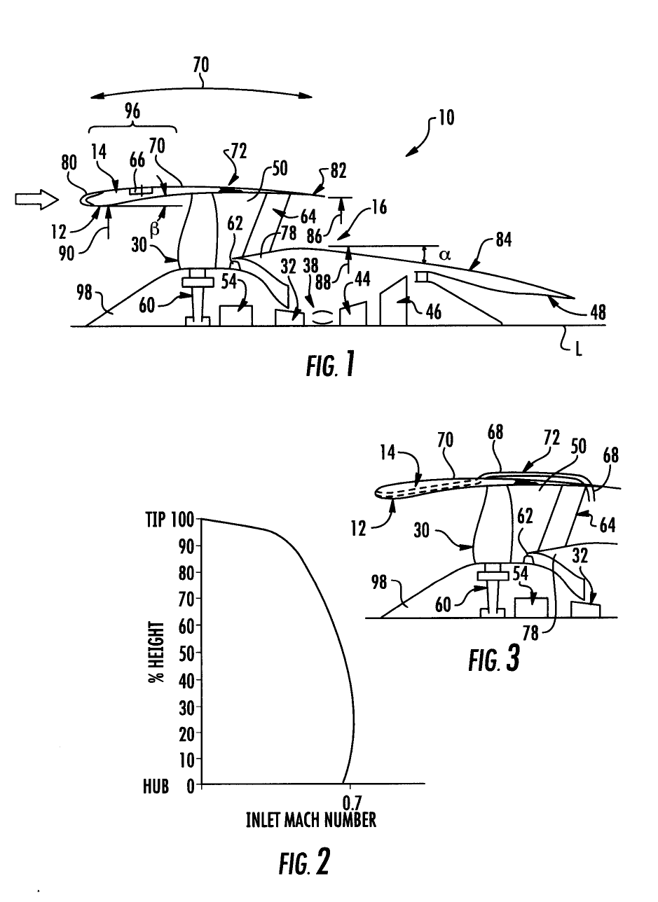

FIG. 1 is a diagram showing an ultra high bypass ratio (BPR) turbofan engine 10 according to an embodiment. The major components of the illustrative turbofan engine 10 include an inlet 12, a nacelle 14, and a two-spool design gas turbine engine 16. The gas turbine engine 16 includes, in axial flow series, a propulsive fan 30 (also referred to herein as a low pressure compressor 30), a high pressure compressor 32, a combustor 38, a high pressure turbine 44, a low pressure turbine 46, and an exhaust nozzle 48. The low and high pressure compressors 30, 32 are mechanically interconnected to the respective low and high pressure turbines 46, 44 via respective concentrically disposed shafts (not shown). Although the ultra high BPR turbofan engine 10 is described herein as employing a two-spool design gas turbine engine 16, it will be understood by those skilled in the art that a single-spool or three-spool, or other turbofan machinery configuration, can alternatively be employed.

In operation, the propulsive fan 30 accelerates, that is pressurizes, air entering the inlet 12 to produce a core airstream into the high pressure compressor 32, and a bypass airstream into a bypass duct 50. The bypass duct 50 directs the bypass airstream of pressurized air to flow around (bypass) the core of the ultra high BPR turbofan engine 10 to provide a component of the thrust output of the turbofan engine 10. The high pressure compressor 32 compresses the core airstream of pressurized air, and the compressed air exhausted from the compressor 32 is directed into the combustor 38 where it is mixed with fuel and the mixture is combusted. The resultant hot combustion products then expand through, and thereby drive, the low and high pressure turbines 46, 44. The low and high pressure turbines 46, 44, in turn, drive the respective propulsive fan 30 and high pressure compressor 32 via the respective interconnecting shafts. Downstream of the low pressure turbine 46, the core airstream of hot combustion products is exhausted through the exhaust nozzle 48 to provide additional propulsive thrust. As will be described in greater detail below, the ultra high bypass ratio (BPR) turbofan engine 10 can be configured with unique combinations of architectural components and cycle parameters, including for example the inlet 12, the nacelle 14, fan pressure ratios, operating Mach numbers, among others, that significantly reduce fuel consumption and noise.

The ultra high bypass ratio (BPR) turbofan engine 10 is configured to have a bypass ratio of about 19 to 26, which in one form can be at cruise, as will be appreciated. Other bypass ratios outside the 19 to 26 range may also be suitable. For example, a bypass ratio below 19 and as low as 18, although effective in combination with various architectural components, cycle parameters, and aero parameters described herein, will generally result in less fuel burn reduction and less noise reduction. Similarly, it has been found that a bypass ratio greater than 26 and as high as 40, although suitable, comes with penalties incurred with respect to installing the larger diameter structure in the airframe in order to realize the higher bypass ratio, reducing the benefits of fuel burn reduction and noise reduction due to factors such as one or more of space under the wing to accommodate the larger diameter, higher landing gear, and/or higher mounted airframe considerations.

The ultra high bypass ratio (BPR) turbofan engine 10 of the illustrative embodiment operates at a subsonic fan blade entry velocity. Subsonic fan blade entry velocities can minimize noise generated by the propulsive fan 30. Further, subsonic fan velocities can enable relatively greater efficiency when applied together with an ultra high BPR configuration.

The ultra high BPR turbofan engine 10 can be configured to operate at a fan pressure ratio of between about 1.15 and about 1.24, and more specifically about 1.18 to about 1.22. As the propulsive fan 30 size becomes higher, the fan pressure ratio becomes lower; and as the fan pressure ratio becomes lower, the fan propulsive efficiency becomes higher. In the illustrative embodiment, fan pressure ratios lower than about 1.18 are possible but may require more costly fan blade bearing (pitch-adjusting bearing) sizing to maintain a suitable fan hub to tip ratio. If the fan blade bearings are thus sized, the ultra high BPR turbofan engine 10 can operate at a fan pressure ratio of as low as about 1.15. Fan pressure ratios greater than about 1.22 are also possible in the present embodiment, but are limited by the aim of reduced noise and the aero design of the propulsive fan 30 blades. A lower fan pressure ratio, although providing improved propulsive efficiency, can also result in an increased fan diameter, and an excessive fan diameter may be impractical to package in an aircraft installation due to penalties in weight, drag, and/or efficiency. Further, for a given propulsive fan diameter, the fan speed is configured for subsonic fan blade entry velocities to minimize fan noise. In the present embodiment, the maximum fan pressure ratio that can be achieved for such a fan diameter and fan speed is about 1.22. As will be appreciated, with a relatively more costly propulsive fan blade aero design, the maximum fan pressure ratio can be increased up to about 1.23 or 1.24.

The ultra high bypass ratio (BPR) turbofan engine 10 includes a reduction gearbox 54 disposed between the low pressure turbine 46 and the propulsive fan 30. In an embodiment, the reduction gearbox 54 has a gear ratio that is greater than or equal to about 4.5 to 1 (4.5:1), for example, 4.6:1, or 6:1, or 6.8:1. The reduction gearbox 54 reduces the speed of the propulsive fan 30 relative to the low pressure turbine 46, which serves to reduce noise and enable lower fan pressure ratios, which, as mentioned above, can increase fan propulsive efficiency. The reduction gearbox 54 can also serve to reduce the length and diameter of the low pressure turbine 46 module, which can translate into a nacelle 14 design having a shorter, smaller diameter core cowl, lowering weight and drag of the nacelle 14.

The propulsive fan 30 comprises a single stage and includes a variable pitch mechanism 60 that varies the pitch of the propulsive fan blades. The variable pitch mechanism 60 serves to prevent or substantially reduce the likelihood of fan operability issues that could otherwise be caused by the ultra high bypass ratio of the ultra high BPR turbofan engine 10. The variable pitch mechanism 60 can prevent or substantially reduce the likelihood of fan surge or stall by varying the pitch of the propulsive fan blades to provide a more stable flow path through the propulsive fan 30 and around the core of the engine 10. As will be described in greater detail below, the variable pitch propulsive fan 30 can also serve to eliminate a thrust reverser from the outer portion of the nacelle 14, so that a smaller outer cowl can be realized. The variable pitch propulsive fan 30 can also enable feathering during engine out conditions to minimize drag.

The ultra high BPR turbofan engine 10 can eliminate sources of noise by using the single stage variable pitch propulsive fan 30, which can result in a significantly lower overall noise level for the ultra high BPR turbofan engine 10. For instance, by using the single stage variable pitch propulsive fan 30, the ultra high BPR turbofan engine 10 can avoid the noise that is typically experienced by counter rotating turbofans with variable pitch, which generate noise by the interactions between the two stages of fans. Further, the single stage variable pitch propulsive fan 30 is less complex and less costly than for example a counter rotation fan, since a counter rotation fan employs two stages and a complex variable pitch mechanism to control the pitch on the second fan, whereas the single stage variable pitch propulsive fan 30 employs a significantly less complex and less costly single stage fan.

In an embodiment, the engine section stator (ESS) vanes 62, or deswirl vanes, are located at or near the entrance to the core of the ultra high BPR turbofan engine 10. The ESS vanes 62 reduce swirl exiting the propulsive fan 30 at the hub. In an alternative embodiment, the ultra high BPR turbofan engine 10 has no ESS vanes 62, and instead relies on for example the axially swept OGVs 64 and/or the low inlet Mach number and/or low throat Mach number, to reduce swirl exiting the propulsive fan 30 and to reduce pressure loss in the ESS duct.

A set of bypass outlet guide vanes (OGVs) 64 are spaced aft of the propulsive fan 30 and connect between the nacelle 14 and the core of the BPR turbofan engine 10. As shown in FIG. 1, the OGVs 64 are axially swept at about 25 to 35 degrees such that the vane tip is axially downstream of its root. The OGVs 64 provide a stiff structure for efficiently transferring structural loads between the nacelle 14 and the core of the ultra high BPR turbofan engine 10 without significant weight, cost, and blockage. Further, owing to their axial sweep, the OGVs 64 provide such structural support without substantial noise and bypass losses. In one form, the axial sweep OGV arrangement 64 generates relatively less noise compared to that of, for example, OGVs that are oriented straight radially along the span of the OGVs. Although not shown in FIG. 1, the OGVs 64 can also be tangentially leaned in the direction of the fan rotation to further reduce noise.

The ultra high BPR turbofan engine 10 can be configured for a max inlet velocity through the OGVs 64 of less than or equal to about 0.7 Mach. Further, with the ultra high BPR turbofan engine 10 configured as such, there may be increased sensitivity to bypass losses, the most significant contribution of such losses being those caused by the by the OGVs 64. Accordingly, the losses through the NGVs in the present embodiment are kept minimal or reduced by keeping the Mach number at 0.7 or below. FIG. 2 shows the inlet Mach number of the ultra high BPR turbofan engine 10 versus the % height (where height is the span from hub to tip). The maximum inlet Mach Number of about 0.7 Mach, or less, provides efficient fuel burn, that is an efficient specific fuel consumption (SPC).

The nacelle 14 of the ultra high BPR turbofan engine 10, according to an embodiment, employs a design in which the size of the outer portion of the nacelle 14 is minimized for a given diameter of the propulsive fan 30, in light of various architectural components, cycle parameters, and aero parameters. The bypass ratio of a turbofan engine can be limited by the weight and drag of the outer portion of the nacelle 14, as the diameter of the propulsive fan 30 increases with increased bypass ratio. The nacelle 14 of the present embodiment is configured to minimize weight and drag based on one or more of the following design parameters: minimizing the number of components within the outer nacelle 14, minimizing the number of functions in the outer cowl 70, maximizing the cold nozzle 82 outer radius 86 and the inlet throat diameter, minimizing the nacelle 14 maximum radius and the inlet contraction ratio, and minimizing the inlet diffuser section 96 length.

In an embodiment, the variable blade pitch feature of the propulsive fan 30 serves as a reverse thruster. Accordingly, the variable blade pitch propulsive fan 30 can be configured to perform the thrust reversing duties of the ultra high BPR turbofan engine 10, for example by selectively reversing the fan blade pitch of the blades of the propulsive fan 30, and thus take the place of a thrust reverser that is typically disposed for example in the nacelle outer portion of separate flow type turbofans. In one form, all or a portion of the accessories and electrical system components (FADECS) of the ultra high BPR turbofan engine 10 can be mounted in the inlet 12, for example, at reference numeral 66 forward of the containment where the diffuser section creates more thickness in the nacelle 14. In another form, all or a portion of the FADECS can be mounted to the core of the turbofan engine 10 and/or remotely mounted in the pylon and/or on the aircraft. As such, the nacelle 14 can be configured without such accessories and/or components, and therefore be made smaller in weight and size.

In the FIG. 1 embodiment, the outer cowl 70 of the nacelle 14 is shown configured with a split line 72 perpendicular to the engine centerline L, aft of the propulsive fan 30 blades and forward of the bypass OGVs 64. With such an outer cowl 70, a crane or hoist can be used to support the inlet 12 as it is pulled axially off the front of the ultra high BPR turbofan engine 10 to provide access to the propulsive fan 30 module for service including, for example, single blade replacement. In an alternative embodiment, the split line 72 can be located forward of the propulsive fan 30 blades, and one or more slots and/or windows can be provided in the outer cowl 70 to enable access to the propulsive fan 30 module, including the blades thereof. In a further embodiment, cowl doors and/or cowl door sections can be provided that can be removed from the outer cowl 70 as a separate piece such that hinges and supporting structure are not required.

The ultra high BPR turbofan engine 10 includes a forward engine mount in the engine area located at reference numeral 78 that mounts the engine to a pylon or the aircraft's airframe structure. In one embodiment (not illustrated), the forward engine mount 78 can be mounted on the outer cowl 70 above the OGVs 64. The forward engine mount 78 can be mounted to the outer cowl 70 to protrude from the outer cowl nacelle loft line and be enclosed within a pylon connected to the aircraft's structure. In the illustrative embodiment, the forward engine mount 78 is mounted to the core of the ultra high BPR turbofan engine 10. Mounting the forward engine mount 78 to the core can be facilitated in part by a reduced size outlet cowl 70, particularly a reduced length outer cowl 70, as described herein. Mounting the forward engine mount 78 to the core can provide greater access to the core for engine mounting structures and for servicing core mounted accessories. Further, mounting the forward engine mount 78 to the core rather than for example to the outer cowl 70, can eliminate or substantially reduce core engine reaction loads from being transferred through the OGVs 64 to the forward engine mount 78 on the outer cowl 70. By reducing the loads experienced by the OGVs 64, and by reducing the services needing to pass through the OGVs 64, for example by core mounting accessories, the OGVs 64 can be designed thinner, resulting in less drag, less pressure loss, and improved fuel burn.

An inlet deicing or anti-icing device can be incorporated into the ultra high BPR turbofan engine 10 in any suitable manner. In one form, the inlet deicing or anti-icing device can comprise an electrical deicing device, which can simplify design of a composite outer cowl 70. In another form, the inlet deicing or anti-icing device can use bleed air for inlet deicing.

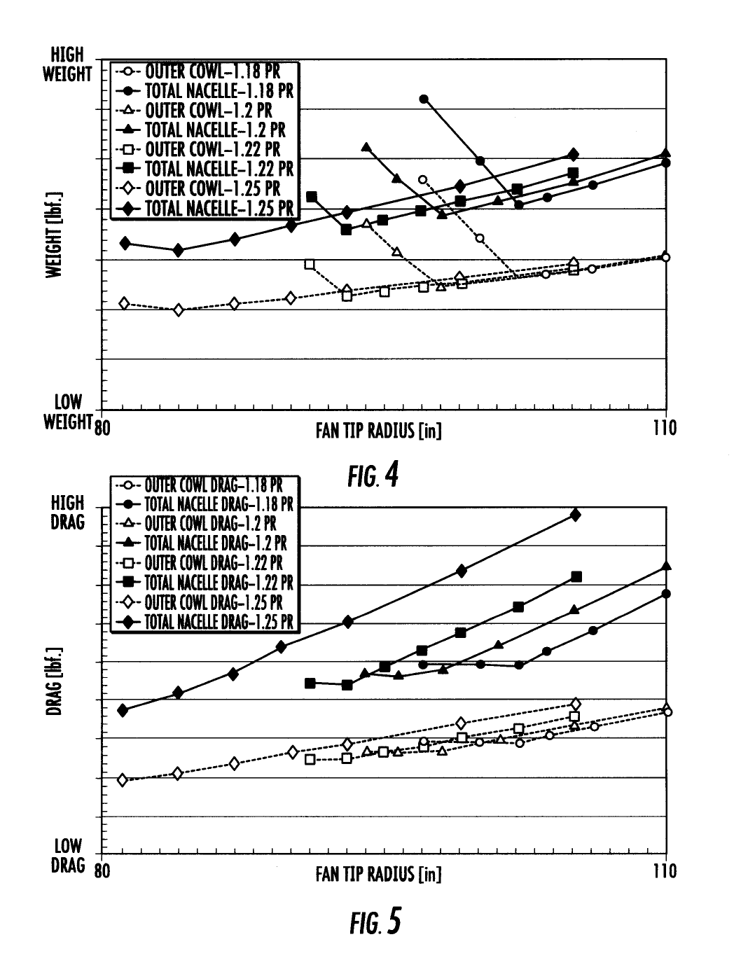

FIG. 3 shows an embodiment of a bleed air inlet anti-icing system incorporated into the nacelle 14 without increasing the thickness of the outer cowl 70. The bleed air inlet anti-icing system can include a bleed air supply tube 68 that runs outside the outer nacelle outer loft line until it is forward of the blade containment region, where the tube 68 enters the inlet 12 and serves an anti-icing function in the forward end of the inlet 12. The anti-icing tube 68 can be contained in a cowling along the top of the ultra high BPR turbofan engine 10. As will be appreciated, the drag loss from the bleed air supply tube 68, or “bump”, just outside the outer nacelle outer loft line is substantially less than a drag loss that would occur if the thickness of the outer cowl 70 were increased to contain the tube 68, particularly because increasing the outer cowl 70 thickness also increases the length of the outer cowl 70 making the drag penalties steep.

The inlet 12 can be slatted 80 to enable the contraction ratio of the inlet 12 to be reduced. In an alternative embodiment, the inlet 12 may not be slatted, for example, where the trade of a larger inlet contraction ratio is acceptable or more desirable, or where the aerodynamics of the inlet 12 do not require a large inlet contraction ratio.

There is a trade based on the radius at which the cold nozzle 82 is located. If the cold nozzle 82 is at a larger radius, the outer cowl 70 will be shortened, reducing outer cowl 70 weight and drag. But as the core cowl 84 becomes larger, core cowl 84 weight and drag increase. If the cold nozzle 84 is at a smaller radius, the opposite effects occur. According to an embodiment, the cold nozzle 82 is placed at the largest practical radius; that is, the cold nozzle outer radius 86 is at a radius near or slightly above the fan tip radius. As one example, the cold nozzle 82 outer radius 86 can be within about 5% of the fan tip radius. This has the added benefit of increasing the core cowl 84 afterbody, or boat tail, angle α (alpha). The afterbody angle α can be set by the inner radius 88 of the cold nozzle 82 and the diameter at the aft end of the ultra high BPR turbofan engine 10, that is the diameter approximately at the downstream end of the low pressure turbine 46 (plus nacelle wall clearance and thickness). So the larger the cold nozzle 82 radius, the steeper the boat tail angle α can be. As the cold nozzle 82 is pulled forward, this tends to decrease the core cowl 84 afterbody angle α, resulting in a longer core cowl 84. Increasing the core cowl 84 afterbody angle α (within aerodynamic limits for avoiding excessive drag) can help reduce the length of the core cowl 84, reducing weight and drag which will improve aircraft fuel burn. Accordingly, in the present embodiment, the cold nozzle 82 should be near the fan tip radius, for example, within about 5% of the fan tip radius.

The outer radius of the nacelle 14 can be minimized to reduce the overall weight and drag of the ultra high BPR turbofan engine 10. The maximum outer radius of the nacelle 14 is approximately above, that is radially outside, the propulsive fan 30 blade tip radius. By removing components and/or functions from the outer cowl 70 in the manner such as described herein, the minimum thickness of the nacelle 14 can be based substantially on manufacturing and/or structural requirements. Depending on the quantity and type of components and/or functions removed, the nacelle 14 can have a thickness in the range of, for example, about three (3) to six (6) inches. For some cycle parameters, the outer nacelle 14 thickness can be set to avoid spillage drag at the inlet 12, which is described in greater detail below.

The designs of the inlet 12 and the outer cowl 70 are also based on the throat diameter 90 of the inlet 12 and the associated inlet spillage drag and throat Mach number. The throat diameter 90 of the inlet 12 can be maximized based on the maximum outer radius of the nacelle 14, and the inlet spillage drag that occurs at the end of cruise. As the throat diameter 90 of the inlet 12 increases, the throat Mach number decreases, the highlight radius increases, and the inlet diffuser section 96 length increases (assuming a set, maximum diffuser angle). A shorter diffuser section means a shorter inlet 12 and potentially a shorter overall outer cowl 70 and/or a better overall aerodynamic solution due to the cold nozzle 82 to core afterbody angle α relationship discussed herein. Where the nacelle 14 maximum outer radius is set, for example, by the minimum manufacturing and/or structural thickness above the propulsive fan 30 blade tip radius, an upper limit on throat diameter 90 can be set based on the inlet spillage drag at the end of cruise. The amount of inlet spillage drag can become excessive at the onset of inlet spillage drag. To avoid or substantially reduce such inlet spillage drag, the inlet throat diameter 90 can be sized slightly less than the diameter at which inlet spillage drag occurs at the end of cruise. This will result in the maximum inlet throat diameter 90 in conjunction with the nacelle 14 maximum outer radius set by the minimum manufacturing and/or structural thickness above the propulsive fan 30 blade tip radius. Where the inlet throat diameter 90 is so low as to generate unacceptable or undesirable high throat Mach numbers, the inlet throat diameter 90 and the nacelle 14 maximum outer radius may be further modified.

According to an embodiment, the throat Mach number can be less than or equal to 0.72 M. If the inlet throat diameter 90 is decreased to reach a throat Mach number of about 0.74 M and the inlet spillage drag continues to occur at the end of cruise, then the inlet throat diameter 90 can be set at a value where the maximum throat Mach number is about 0.74 and the nacelle 14 maximum outer radius can be increased to a value at which the inlet spillage drag is avoided. However, this may have the effect of undesirably or unacceptably increasing the length, weight and drag of the outer nacelle 14, and thus the throat Mach number may be further modified.

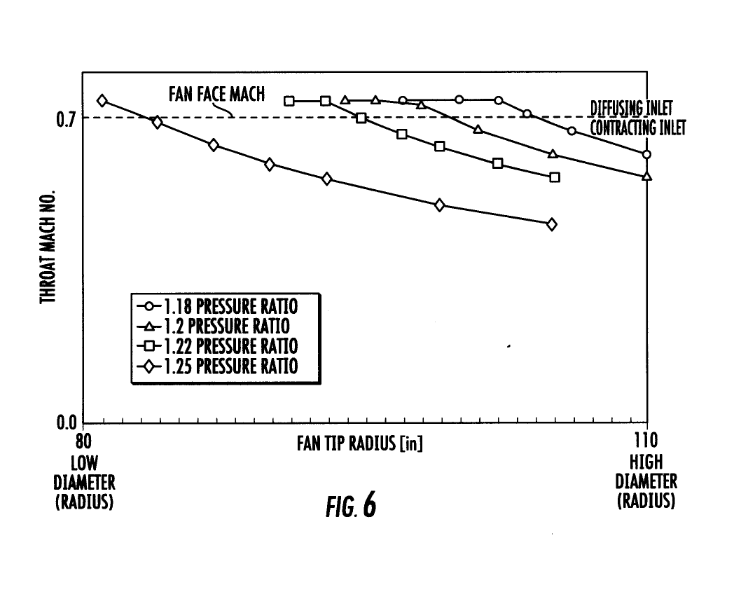

FIG. 4 shows an approximate nacelle 14 weight as a function of the propulsive fan 30 tip radius for several fan bypass ratios. As can be seen, once the propulsive fan 30 diameter is low enough for the inlet throat to reach the maximum allowable Mach number, starting an increase in the nacelle 14 maximum radius, the weight begins to increase at a steep rate. FIG. 5 shows the trend for nacelle 14 drag as a function of the propulsive fan 30 tip radius and fan pressure ratio. The nacelle 14 drag reduces with fan diameter until the maximum allowable throat Mach number is reached. From that point, the nacelle 14 drag is essentially level as the propulsive fan 30 tip radius decreases. FIG. 6 shows a graph of the throat Mach number versus the propulsive fan 30 tip radius at various fan pressure ratios. The propulsive fan blade tip can comprise any suitable contour; in one embodiment the propulsive fan blade tip has a spherical fan blade tip contour to provide tip clearance control. As the propulsive fan 30 diameter decreases, the throat Mach number increases until it reaches a maximum allowable throat Mach number. In an embodiment, the propulsive fan 30 diameter can be large enough to avoid the maximum allowable inlet throat Mach number. Thus, for a fan face Mach number of 0.7 M, the propulsive fan 30 can have a throat Mach number near or below the fan face Mach number. A throat Mach number less than the fan face Mach number would end up with a “diffuser” section that contracts the flow up to the fan face. This could be beneficial in shortening the diffuser section since separation is less likely in a contracting flow field, and therefore the “diffuser” section geometry can be more aggressive.

As will be appreciated from the embodiments illustrated in FIGS. 4 through 6, an optimum design space can be selected, for example, as occurs when the propulsive fan 30 tip radius is large enough to allow the throat Mach number to be below the maximum allowable. The throat Mach number can be near or slightly below the fan face Mach number to enable more aggressive geometry within the inlet while still avoiding separation. Based on these aero and cycle parameters, the throat Mach number according to the present embodiment is less than or equal to about 0.72 M.

Referring briefly in detail to FIGS. 4 and 5, the distance between the two sets (upper and lower) of lines is fairly constant. Thus, with respect to FIG. 4 (weight), for example, where comparison is made between the outer cowl weight and the total nacelle weight (the core cowl being roughly the same), it can be seen that the outer cowl can add/or subtract weight and thus FIG. 4 can be used for example to minimize the outer cowl weight, thickness, size, etc., as described herein, to reduce fuel burn, for example. A similar conclusion and use can be drawn from FIG. 5 (drag), as will be appreciated.

FIGS. 4 through 6 show results according to one embodiment of an ultra high BPR turbofan engine 10, and other embodiments are contemplated. FIGS. 4 through 6 show the trends can vary depending on the application. For example, the fan tip radius can vary based on an application, for example, the large civil aircraft market, the middle of the market, and the regional airliners. As will be appreciated by those skilled in the art, in other embodiments the values may be different depending on the specific application, and can vary with different materials and technologies included in the embodiment.

According to an embodiment, the ultra high BPR turbofan engine 10 can comprise an ultra high bypass ratio resulting in improved fuel burn and noise by combining architecture components and cycle parameters that include for example a low fan pressure ratio, for example, between about 1.15 and about 1.24, which can be provided by, for example, the reduction gearbox 54 and the variable pitch propulsive fan 30 described herein, low loss outlet guide vanes (OGVs) 64, which can take the form of for example the axial sweep OGV arrangement 64 and the low Mach number described herein, the nacelle 14 architecture described herein, which serves to reduce the weight and drag of the propulsive fan 30, and the low speed propulsive fan 30, which serves to reduce noise and improve propulsive fan 30 efficiency in combination with the aforementioned ultra high bypass ratio.

The ultra high BPR turbofan engine 10 can be configured to have an inlet contraction ratio for avoiding separation of oncoming airflow from the inlet lip section during engine operation of about 1.10 to about 1.15. The inlet contraction ratio can be based on, for example, the relationship between the throat diameter 90 of the inlet 12, the nacelle 14 maximum outer radius at which inlet spillage drag begins, and the length of the inlet 12. As the inlet contraction ratio increases, the highlight diameter increases, pushing out the nacelle 14 maximum outer radius at which inlet spillage drag begins. The length of the contraction portion of the inlet 12 also increases with increased inlet contraction ratio. In an embodiment, an inlet contraction ratio of about 1.10 to about 1.15 can be provided by a slatted inlet 12 design. In an alternative and/or additional embodiment, an inlet contraction ratio of about 1.10 to about 1.15 can be provided by modifying cycle parameters so that the inlet 12 is less sensitive to contraction ratio. For example, at higher bypass ratios, such as the ultra high bypass ratios described herein, the inlet contraction ratio can be reduced to as low as about 1.10. The ultra high BPR turbofan engine 10 can be configured for an inlet contraction ratio of 1.15 or less for example in the case where there are fewer architectural parameters and cycle parameters for reduced fuel burn and reduced noise described herein.

The inlet diffuser section 96, which is along the outer portion of the flow path, extends from the fan face to the throat diameter 90. The length of the inlet diffuser section 96 can be set by the radial difference between the throat diameter 90 and the fan tip along with a maximum allowable diffuser angle β to avoid separation. In one embodiment, the length of the diffuser section 96 can be minimized first by maximizing the throat diameter 90 as described herein. Additionally, or alternatively, the length of the diffuser section 96 can be reduced by maximizing the diffuser angle β prior to separation. This can be augmented by adding a form of flow control to enable a larger diffuser angle β prior to separation, such as by use of microramps, microjets, air injection or suction, or plasma generators. The inlet diffuser section 96 can also be shortened by for example setting the throat Mach number near or below the fan face Mach number. In so doing, separation is less likely to occur (as described herein) and more aggressive geometry can be implemented, shortening the diffuser section 96.

According to an embodiment, the hub to tip ratio of the variable pitch propulsive fan 30 can be made larger than for example a fixed pitch fan. This, combined with a larger fan tip radius of the ultra high BPR turbofan engine 10, can result in a relatively larger, longer spinner 98 that interacts with the inlet 12 more than in a typical turbofan. According to an embodiment, an end inlet design can be shortened by designing the spinner 98 in conjunction with the inlet 12. A larger spinner 98 can also be contoured to interact with the inlet 12 for a shorter length diffuser section 96.

Any theory, mechanism of operation, proof, or finding stated herein is meant to further enhance understanding of embodiment of the present disclosure and is not intended to make the present disclosure in any way dependent upon such theory, mechanism of operation, proof, or finding. In reading the claims, it is intended that when words such as “a,” “an,” “at least one,” or “at least one portion” are used there is no intention to limit the claim to only one item unless specifically stated to the contrary in the claim. Further, when the language “at least a portion” and/or “a portion” is used the item can include a portion and/or the entire item unless specifically stated to the contrary.

While embodiments of the invention have been illustrated and described in detail in the drawings and foregoing description, the same is to be considered as illustrative and not restrictive in character, it being understood that only the selected embodiments have been shown and described and that all changes, modifications and equivalents that come within the spirit of the disclosure as defined herein of by any of the following claims are desired to be protected. It should also be understood that while the use of words such as preferable, preferably, preferred or more preferred utilized in the description above indicate that the feature so described may be more desirable, it nonetheless may not be necessary and embodiments lacking the same may be contemplated as within the scope of the disclosure, the scope being defined by the claims that follow.

1. An ultra high bypass ratio turbofan engine comprising
a bypass ratio between about 18 and about 40;
a variable pitch fan;
a low pressure turbine; the variable pitch fan and the low pressure turbine coupled together by a reduction gearbox that reduces the speed of the variable pitch fan relative to the low pressure turbine; and
a plurality of outlet guide vanes that are spaced aft of the variable pitch fan and are axially swept;
the variable pitch fan and the low pressure turbine being configured to generate a fan pressure ratio between about 1.15 and about 1.24.

2. The ultra high bypass ratio turbofan engine of claim 1, in which the bypass ratio is between about 19 and about 26.

3. The ultra high bypass ratio turbofan engine of claim 1, in which the variable pitch fan comprises a single stage variable pitch fan.

4. The ultra high bypass ratio turbofan engine of claim 1, in which the ratio of the reduction gearbox is greater than or equal to about 4.5:1.

5. The ultra high bypass ratio turbofan engine of claim 1, in which the outlet guide vanes are axially swept about 25 to 35 degrees.

6. The ultra high bypass ratio turbofan engine of claim 1, in which the outlet guide vanes are tangentially leaned in the direction of rotation of the variable pitch fan.

7. The ultra high bypass ratio turbofan engine of claim 1, in which the variable pitch fan and the low pressure turbine are configured to generate a fan pressure ratio between about 1.18 and about 1.22.

8. The ultra high bypass ratio turbofan engine of claim 1, further comprising an inlet that surrounds the variable pitch fan, wherein the inlet and the variable pitch fan are configured for a max inlet velocity through the outlet guide vanes of less than or equal to about 0.7 Mach.

9. The ultra high bypass ratio turbofan engine of claim 1, in which the variable pitch fan is configured to selectively operate as a thrust reverser.

10. The ultra high bypass ratio turbofan engine of claim 1, further comprising an inlet configured for a throat Mach number of less than or equal to about 0.72 Mach.

11. An ultra high bypass ratio turbofan engine comprising
a bypass ratio between about 18 and about 40;
a propulsive fan;
a low pressure turbine, the propulsive fan and the low pressure turbine coupled together by a reduction gearbox, wherein the reduction gearbox reduces the speed of the propulsive fan relative to the low pressure turbine so that propulsive fan blade entry velocities are subsonic;
an inlet that surrounds the propulsive fan; and
a plurality of outlet guide vanes that are spaced aft of the propulsive fan;
wherein the inlet and propulsive fan are configured for a max inlet velocity through the outlet guide vanes of less than or equal to about 0.7 Mach.

12. The ultra high bypass ratio turbofan engine of claim 11, in which the inlet has an inlet contraction ratio of about 1.15 or less.

13. The ultra high bypass ratio turbofan engine of claim 11, in which the inlet is slatted to provide an inlet contraction ratio of about 1.15 or less.

14. The ultra high bypass ratio turbofan engine of claim 11, in which the inlet has a throat Mach number of less than or equal to about 0.72 M.

15. The ultra high bypass ratio turbofan engine of claim 11, in which the outlet guide vanes are axially swept about 25 to 35 degrees.

16. An ultra high bypass ratio turbofan engine comprising
a bypass ratio between about 18 and about 40;
a single stage variable pitch fan and a low pressure turbine coupled together by a reduction gearbox, wherein the reduction gearbox reduces the speed of the single stage variable pitch fan relative to the low pressure turbine and the ratio of the reduction gearbox is greater than or equal to about 4.5:1; and
a plurality of outlet guide vanes that are spaced aft of the propulsive fan and are axially swept.

17. The ultra high bypass ratio turbofan engine of claim 16, in which the variable pitch fan is configured to selectively operate as a thrust reverser.

18. The ultra high bypass ratio turbofan engine of claim 16, further comprising a nacelle that includes an outer cowl configured with a split line aft of the blades of the variable pitch fan and forward of the outlet guide vanes, the split line enabling axial removal of the outer cowl from the ultra high bypass ratio turbofan engine.

19. The ultra high bypass ratio turbofan engine of claim 18, further comprising a forward engine mount mounted on the outer cowl above the outlet guide vanes.

20. The ultra high bypass ratio turbofan engine of claim 16, further comprising a nacelle that includes a cold nozzle and the cold nozzle has an outer radius that is within about 5 percent of the fan tip radius of the variable pitch fan.
